(19) United States
(12) Patent Application Publication
(10) Pub. No.: US 2014/0305776 A1
(43) Pub. Date: Oct. 16, 2014

(54) TABLE PLATES FOR MACHINES FOR TREATING CONTAINERS

(71) Applicant: KRONES AG, Neutraubling (DE)

(72) Inventors: Dieter Hafner, Regensburg (DE); Tobias Eichhammer, Bad Abbach (DE); Bernhard Högl, Rohr (DE); Andreas Bergers, Pfatter (DE)

(73) Assignee: KRONES AG, Neutraubling (DE)

(21) Appl. No.: 14/282,681

(22) Filed: May 20, 2014

Related U.S. Application Data
(63) Continuation of application No. 14/179,629, filed on Feb. 13, 2014.

(30) Foreign Application Priority Data
Apr. 15, 2013 (DE) 10 2013 206 667.8

(51) Int. Cl. B65G 41/00

(52) U.S. Cl. CPC B65G 41/006
USPC 198/860.3

(57) ABSTRACT

A table plate for a machine for treating containers, particularly a labeling machine, said table plate comprising a carrousel portion where a carrousel can be positioned and pivotally connected to the table plate; said table plate comprising a rotating star-shaped element region where at least one rotating star-shaped element for supplying or discharging containers to or from the carrousel can be arranged and pivotally connected to the table plate; said table plate being formed as a solid and one-piece work piece.

The present invention relates to a machine for treating containers and to table plates for machines for treating containers, particularly labeling machines.

### STATE OF THE ART

Machines for treating containers and also table plates are known from the state of the art.

WO 2011/027372 for instance shows a machine for treating containers provided with a supporting frame with guides to which labeling units can detachably be connected so that they can be placed at specific positions around a carrousel.

Further, WO 2011/045819 A1 shows a supporting structure with supply means and rotating star-shaped elements that are mounted on a table plate being arranged thereto as well as a separate support structure for supporting a carrousel.

### PROBLEM

Based on the state of the art it is the problem of the invention to provide the best effective modular structure for machines for treating containers such as labeling machines allowing for easy assembly and effective manufacture thereof.

### SOLUTION

According to the invention, this problem is solved by means of the machine for treating containers according to independent claim 1 as well as the table plates according to independent claims 7, 14 and 27.

Any advantageous developments of the invention are included in the dependent claims.

The machine for treating containers according to the invention, e.g. a labeling machine, comprises a portal and a base support with a carrousel for receiving containers to be treated therein and is characterized in that the portal has an opening for transporting containers to be treated to the carrousel, said opening being restricted by a support element provided with supports for supporting said portal at the ground, an upper part to which at least a part of said carrousel is mounted, and two connecting elements for connecting said support element and said upper part with one another, said upper part extending from one connecting element to the other connecting element. Owing to the presence of a corresponding portal and a base support, fast and simple mounting of the labeling machine has become possible, on the one hand, with elaborate adjustment steps partly, preferably entirely, being omitted. Besides, such components can be transported easier.

Furthermore, the portal can be provided with at least one component for operating the machine for treating containers, preferably a control cabinet or an electric or a pneumatic component. Thus, a compact structure of the machine for treating containers could be realized.

According to another embodiment, the machine for treating containers is characterized in that said upper part is connected to the carrousel such that a torque support of the carrousel is performed by the upper part. Therefore, the torque support function can be done by the portal, particularly the upper part thereof, thus omitting any additional components.

According to one embodiment, the base support is at least mounted to the support element by fastening means. Thus, stabilization of the portal and the base support one below the other could be ensured and the orientation of said units simultaneously enabled.

Furthermore, the base support may comprise support elements for holding the base support at the ground. Thus, the base support can be supported independently at the ground of a factory hall and, if required, be oriented correspondingly.

Furthermore, an assortment of machines for treating containers may be provided which is characterized in that the portal dimensions for each of said assortment container treating machines are indeed identical, the size of the carrousel may, however, differ from one another.

Such an assortment can be manufactured at distinctly lower costs, and replacing any faulty portals of machines for treating containers has thus also become very easy.

The technical problem is further solved by means of a table plate for a machine for treating containers, in particular a labeling machine, said table plate comprising a carrousel portion where a carrousel can be positioned and pivotally connected to the table plate, and said table plate comprising a rotating star-shaped element region where at least one rotating star-shaped element for supplying or discharging containers to or from the carrousel can be arranged and pivotally connected to the table plate, the table plate being formed as a solid and one-piece workpiece. Such table plate allows for a simplified mounting of carrousels and rotating star-shaped elements which are already oriented with regard to each other to some extent, if not entirely, by said table plate.

According to one embodiment, the table plate is characterized in that said table plate comprises a motor region where motors can be arranged inside and/or outside at the side of the carrousel position of the table plate. This enables a compact structure including the motors that are required to drive rotating star-shaped elements and also the carrousel.

According to yet another embodiment, said motors can be arranged in columns provided on the table plate. By positioning motors in the columns provided, said motors are protected against environmental influences, especially adhesives or any liquids splashing around.

Furthermore, the carrousel and a portal through which containers can either be supplied to or discharged from the carrousel can be connected with one another via the table plate. Such a connection facilitates, preferably even entirely obviates the need for any leveling.

According to one embodiment, the side of the table plates facing away from the carrousel position is provided with elements for guiding and fastening electrical and mechanical systems. This ensures a compact structure and simultaneously protects the electrical and mechanical systems against environmental influences, especially against adhesives or liquids used in said carrousel.

Furthermore, an assortment of table plates for an assortment of machines for treating containers can be provided, wherein the outer dimensions of the rotating star-shaped element region for each of said machines for treating containers among the assortment of machines for treating containers are identical, and a distance of receptacles in a table plate for a rotary wheel or an inlet star and a rotary wheel of an outlet star in said rotating star-shaped element region where the rotating star-shaped elements can be pivotally supported for machines for treating containers among the assortment of machines for treating containers differ from each other. Such an assortment and particularly the corresponding table plates can be manufactured much easier than table plates that have to be adapted individually for each machine for treating containers, thus obtaining a considerably reduction of costs for the production of table plates.

Moreover, the outer dimensions of the carrousel region of at least two table plates among the assortment may differ from each other, and a position in which a main axis of the carrousel can be arranged and pivotally supported in said carrousel portion of at least two table plates of the assortment can show a different distance from the rotating star-shaped element region.

Furthermore, the problem is solved by a table plate for a machine for treating containers, particularly a labeling machine, which comprises a carrousel, wherein at least said carrousel can be mounted to the table plate, said table plate comprising, at a side facing away from a carrousel position, a mounting arrangement supported by said table plate and to which treating units can be mounted. This allows for a central arrangement of e.g. treating units, thus simultaneously supplying a high degree of stability.

According to one embodiment, the mounting arrangement is composed of at least two, a first and a second, ring-shaped elements arranged one upon the other concentrically with regard to a rotation axis of the carrousel and towards the rotation axis of the carrousel, the first ring-shaped element being connected to the table plate via a connection. Such a design of the table plate and of the mounting arrangement allows for a more flexible provision of the mounting arrangement in dependency of the treating units or any other means. Instead of two ring-shaped elements only one ring-shaped element may be provided.

The first ring-shaped element may have a larger inner diameter than the second ring-shaped element, thus producing an internal groove which allows for safe mounting of devices.

Furthermore, the first ring-shaped element may have a smaller outer diameter than the second ring-shaped element. Here, too, safe mounting is ensured and, in combination with the above embodiment, a double-sided groove is provided which, in contrast to a simple groove, allows for higher strength of the connection.

According to another embodiment, the mounting arrangement and the table plate are integrally formed and made of one workpiece. Such a table plate with mounting arrangement made of one single piece further increases the strength and reduces any possible mounting faults.

According to yet another embodiment, the mounting arrangement is formed in a C-shape and/or in the form of a groove.

Furthermore, the mounting arrangement may comprise notches converging towards the rotation axis of the carrousel in table plate direction, and/or the mounting arrangement may comprise notches diverging from the rotation axis in table plate direction. Thus, it has become easier to introduce devices to be mounted, such as treating units.

To solve this problem, a table plate can be provided for a machine for treating containers, particularly a labeling machine which comprises a carrousel to be arranged at the table plate, characterized in that the table plate includes a laminated core material. As it is, thus, not required to produce a table plate that is completely made of e.g. stainless steel or another metal this may result in considerable weight savings and also cost savings with regard to the manufacture, especially if plastics are used for lamination.

The core material may include stainless steel or non-stainless steel or aluminum.

According to one embodiment, the lamination is made of or includes a plastic material. This results in weight savings, particularly with regard to a table plate of the same dimensions and fully consisting of the core material; at the same time, the plastic material may include certain additional advantageous properties.

According to yet another embodiment, the table plate is provided with a bore designed to mount machine parts, wherein a ring-shaped component is inserted into said bore. Here, the ring-shaped component can protect the lamination of the table plate and, simultaneously, be formed in accordance with the requirements of the machine part to be mounted. The ring-shaped component may at least partially be made of stainless steel. Stainless steel is used to render the ring-shaped component robust and as unsusceptible against moistening with liquids and, thus, oxidization, as possible.

Further, the table plate may be of such a design that it comprises at least one or several of the following features: dirt-resistant, color-resistant, flexible, non-sticky and provided with bulges. These additional properties of the plastic coating may be advantageous either individually or in combination which depends on the use intended for the table plate and may facilitate cleaning thereof.

Further provided is a table plate for a machine for treating containers, particularly a labeling machine which comprises a carrousel to be arranged at the table plate, wherein containers to be treated can either be conveyed to or from to the carrousel by means of rotating star-shaped elements to be arranged at the table plate, characterized in that columns in which motors for driving the rotating star-shaped elements are mounted to the table plate at the side of the carrousel position, wherein said rotating star-shaped elements may be of an electrically coupled form. Said columns protect the motors against environmental influences, thus increasing durability thereof.

According to one embodiment, means for mounting further components are provided at the side facing away from the carrousel position of the table plate, wherein a coupling of said components can be provided with an electric motor. Owing to such mounting of additional components, same are protected e.g. against adhesives or liquids that may arise while the machine for treating containers is operated.

The motors may be servomotors.

According to yet another embodiment, means for mounting at least one of the wiring, control device, power supply, in particular emergency power supply, pneumatics, lubricating system are provided at the side facing away from the carrousel position of the table plate in the region facing the rotating star-shaped element position. This allows for protection of especially sensitive components such as wirings against contact with liquids.

### BRIEF DESCRIPTION OF THE FIGURES

FIG. 1 schematically shows one embodiment of a machine for treating containers;

FIGS. 2a+b show diverse embodiments of the portal and the base support;

FIG. 3 shows a table plate according to one embodiment;

FIGS. 4a-c show an assortment of table plates according to one embodiment;

FIGS. 5a-cshow an assortment of table plates according to another embodiment;

FIG. 6 shows a table plate according to one embodiment;

FIG. 7 shows a table plate with mounting elements according to one embodiment;

FIGS. 8a-d show mounting elements according to various embodiments;

FIG. 9 shows a laminated table plate according to one embodiment;

FIG. 10 shows a table plate with bores according to one embodiment;

FIG. 11 shows a table plate according to another embodiment;

FIG. 12 shows a table plate with additional mounting elements according to one embodiment.

### DETAILED DESCRIPTION

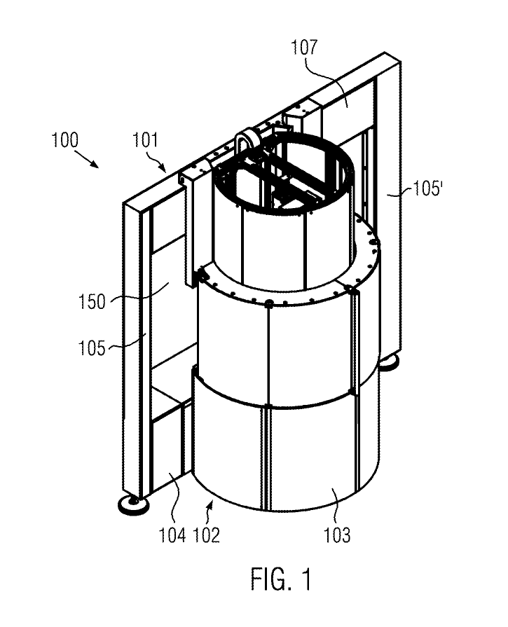

FIG. 1 shows a machine for treating containers according to the invention. This may be, for instance, either a labeling machine or a blow molding machine used to manufacture containers such as bottles. It comprises a portal 101 and a component 102 generally referred to as module for treating containers. The module for treating containers 102 comprises at least a carrousel, here being shown just schematically, as well as a base support 103 on which said carrousel is pivotally supported. Portal 101 has an opening 150 for supplying containers to be treated to a carrousel of the module for treating containers 102 via, e.g. rotating star-shaped elements. The module for treating containers may be, for instance, a labeling machine used for labeling containers. Opening 150 is restricted by components of portal 101. In particular, it is restricted at its sides by connecting parts 105, 105′. The upper side of said bore is restricted by an upper part extending from one connecting part to the other connecting part 105, 105′. The lower side of opening 150 is restricted by a support element 104 of said portal. Such restriction need not to be complete but may also show interruptions. Support element 104 does not only serve to restrict opening 150 but also to support the portal at the ground of a factory hall or the like. Advantageously, upper part 107 can be connected to the module for treating containers 102, preferably to the carrousel, so as to allow for a carrousel torque support by means of upper part 107.

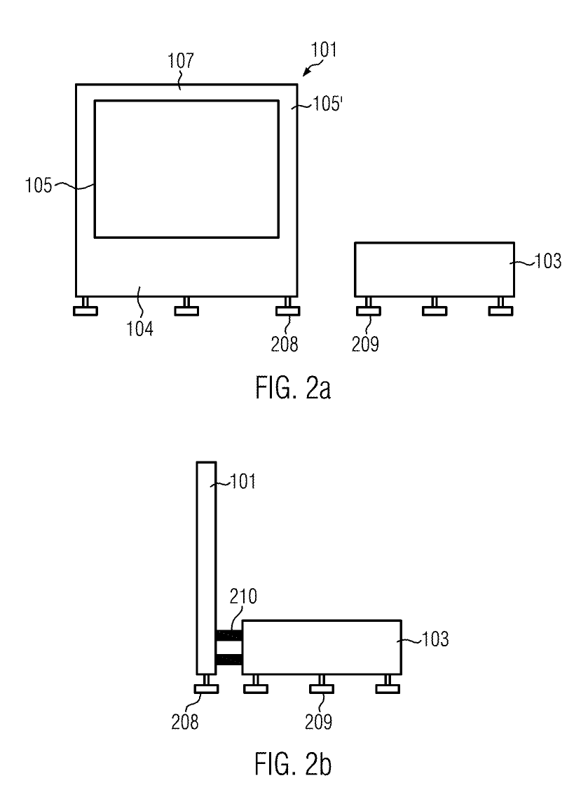

FIG. 2a shows portal 101 and base support 103 separately. Portal and base support 101 or 103 are provided in the form of modules. This means that they are preferably produced separately and can then be connected with one another by means of preferably releasable connections such as fittings. Both the portal 101 and the base support 103 are preferably provided with support elements 208 or 209 which serve to support and align said components.

FIG. 2b shows how the connection 210 between base support 103 and portal 101 can be realized. Although shown here in the form of bolts, such connection can also be realized by snaps, hooks or the like as long as they are designed in such a manner that they remain, once aligned, in their aligned position so as to avoid any undesired misalignment or false positioning while the machine for treating containers is running. A connection via one of the table plates described further below is also conceivable.

Furthermore, one and the same portal 101 may always be used for an assortment of (various) modules for treating containers such as modules for labeling or blow-molding or for bottles or containers of different size. In particular, this means that portal or portals 101 among such an assortment are always of the same dimensions, even if the dimensions of the carrousel and of the base support 103 may vary among the assortment. To achieve this, portal 101 has a size adapted to the various carrousel sizes. In particular, this means that the portal is large enough for each size of a base support 103 and a carrousel used in an assortment in order to allow for supplying and discharging containers to be treated.

Moreover, the means for mounting base support 103 at support element 104 of the portal may be such that corresponding means are provided for each size of base supports among the assortment. For instance, first mounting means may be provided for a first size of a base support 103 among the assortment, said means being fastened to the support element, and second means may be provided for a second size of another base support 103 for being fastened to the support element 104 of said portal. Said first and second mounting means may be provided at different positions, respectively, so that they are adapted to the corresponding base support 103. Alternatively, they may also be provided in the form of a guide to which the corresponding mounting means are attached and which are brought to the desired position according to the size of the base support.

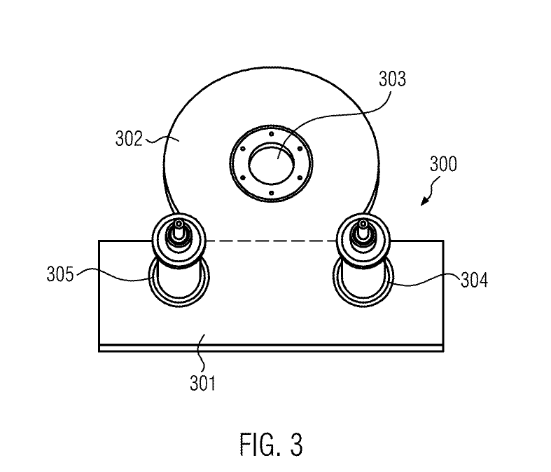

FIG. 3 shows a table plate 300 according to the invention. Said table plate 300 comprises a rotating star-shaped element region 301 with means for positioning and (pivotally) supporting at least one rotating star-shaped element. Said means 304 and 305 can be provided, e.g. in the form of openings or bores into which e.g. a shaft for driving a rotating star-shaped element can be inserted and the rotating star-shaped element can be mounted thereon. Further, table plate 300 comprises a carrousel region 302 with a carrousel being arranged therein and pivotally supported e.g. via a shaft and connected to the table plate. Said means 303 may also be provided e.g. in the form of a bore or opening in said table plate.

Rotating star-shaped element region 301 and carrousel region 302 are divided, for instance, via the dotted line. Even though further divisions are conceivable this turns out to be appropriate. According to the embodiment shown here, rotating star-shaped element region 301 has the form of a rectangle. However, any other form that might be adapted e.g. to specific machines for treating containers is also conceivable. Beyond, to design the carrousel region 302 in the form of a circular part is also not inevitably required and can be altered in accordance with the requirements regarding the machine for treating containers where the table plate are to be used.

In particular it is the intention, however, to make use of the table plate or of an assortment of table plates in a variety of machines for treating containers. Thus, given, standardized dimensions are being used for each table plate among the assortment of table plates, in order to facilitate the manufacture thereof.

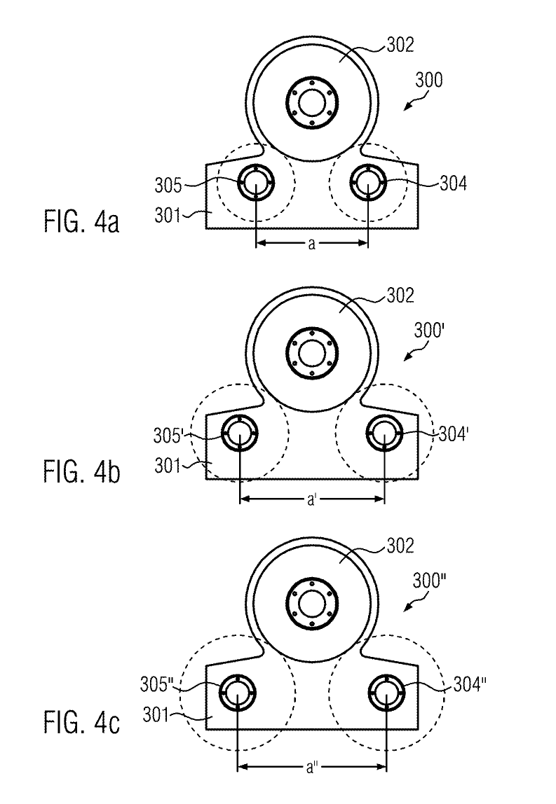

In this connection, FIGS. 4a-c show table plates 300 to 300″ with various rotating star-shaped elements being used. Such rotating star-shaped elements may be characterized, for instance, by various sizes or various required positions with regard to the carrousel to which they shall supply or from which they shall discharge containers. To this, FIGS. 4a-4c show the rotating star-shaped elements and the carrousel by means of sketched circles. The points of contact of said circles specify the transit point for the containers, respectively. Depending on said transit position, the mounting position of the rotating star-shaped element in rotating star-shaped element region 301 of table plates 300 to 300″ is, thus, determined.

FIG. 4a illustrates a table plate 300 with a carrousel region 302 and a rotating star-shaped element region 301. The openings shown here for receiving the rotating star-shaped elements or the shafts 304 and 305 driving same are arranged at specific positions and are spaced apart from each other via a distance a. Such distance results from the position of the means for mounting carrousel 303, as shown in FIG. 3, and from the size of the carrousel itself and the size of the rotating star-shaped elements, as it holds that the distance between the rotation axis of the carrousel and a rotating star-shaped element equals to at least the sum of the radii of the carrousel and the rotating star-shaped element.

FIG. 4b illustrates another table plate 300′. For reasons of clarity, it comprises the same carrousel region 302 (which also implies that the carrousel shall be of the same dimensions as in FIG. 4a) as the table plate shown in FIG. 4a. However, in this case rotating star-shaped elements are used whose diameter varies from that one according to FIG. 4a so that bores 304′ and 305′ have to be positioned at different places in order to provide appropriate transit points for containers from the rotating star-shaped elements to the carrousel and vice versa. Accordingly, the distance between bores 304′ and 305′ is a′. Yet, the rotating star-shaped element region 301 in FIG. 4b has the same outer dimensions as in FIG. 4a.

FIG. 4c illustrates a table plate 300″ into which even still larger rotating star-shaped elements are to be introduced so that the distance between bores 304″ and 305″ is a″ which is even larger than distance a′. Here, too, the outer dimensions of rotating star-shaped element region 301 are, yet, the same.

As displacing of bores during the manufacture of table plates can be technically realized in a relatively simple manner, manufacture becomes much easier, since such plates can be used as table plates for the intended assortment which are always of the same outer dimension of the rotating star-shaped element. If, beyond, the size of the carrousel that is to be used in the assortment of machines for treating containers is always the same, the outer form of the table plate will remain identical among the entire assortment and just the positions of the bores or means for mounting rotating star-shaped elements 304 and 305 have to be varied.

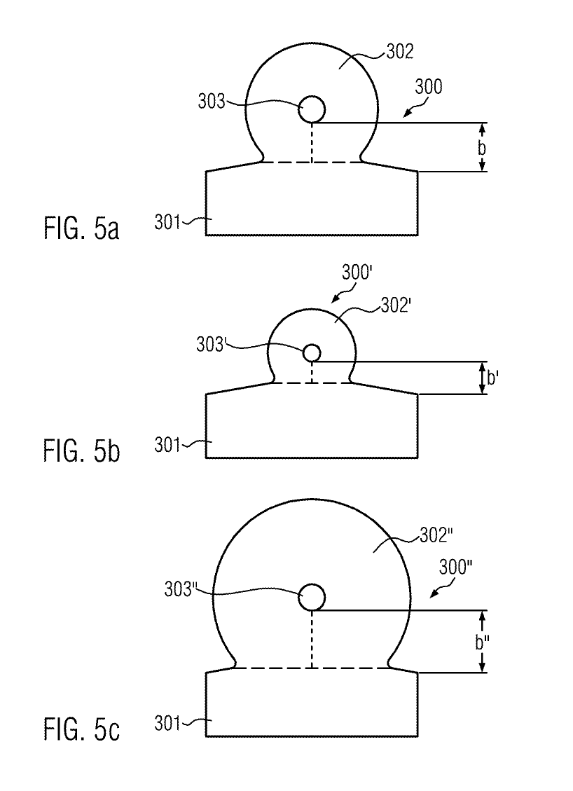

FIGS. 5a-c show another possibility to modify table plate 300 shown in FIG. 3. To this, an assortment of table plates is provided that shall suit to carrousels of different size. According to FIG. 5a, rotating star-shaped element region 301 with dotted restriction is provided, and a carrousel region 302 for the carrousel to be mounted thereon via element 300. Preferably, the size and the form of the carrousel region are adapted to the carrousel. For reasons of simplicity, the distance between the element for mounting carrousel 303 and rotating star-shaped element region 301, here indicated by b, is taken as the characteristic value for the following considerations. Since in case of a given size of a rotating star-shaped element approved as constant value for the following statements the same condition as already described with regard to FIG. 4 has to be met, distance b is, indeed, a characteristic value.

FIG. 5b illustrates another table plate 300′ for mounting another carrousel. Said carrousel can, for instance, be smaller than that one described in FIG. 5a. Assuming that the mounting element 303′ for mounting the carrousel is here also centrally arranged in the carrousel region 302′, there is a distance b′ between mounting element 303′ and rotating star-shaped element region 301 which is smaller than that one shown in FIG. 5a, to ensure the presence of a container transit point. Yet, table plate 300′ has the same rotating star-shaped element region 301 as shown in FIG. 5a.

FIG. 5c illustrates a table plate 300″ also comprising a rotating star-shaped element region 301 of the same dimensions as in the previous Figures. It is, however, designed to a larger carrousel and requires, thus, a larger carrousel region 302″ with a centrally arranged element 303″ for mounting a carrousel. The distance between said element 303″ and rotating star-shaped element region 301 is, thus, b″ and is larger than distances b and b′ according to FIGS. 5a and 5b.

In summary it can be stated that the invention enables to manufacture an assortment of table plates that can be divided into a rotating star-shaped element region and a carrousel region. To this, as shown in FIGS. 4a-c and 5a-c, the rotating star-shaped element region is always of the same outer dimensions among the entire assortment. Depending on specific requirements or the size of a carrousel to be mounted thereon, the carrousel region may take different sizes. However, the constant dimensions of the rotating star-shaped element region render the production process much easier. It is easier to provide differently positioned elements for mounting the rotating star-shaped elements in dependency of the size of said rotating star-shaped elements and of the carrousels in terms of manufacture than custom-made table plates for each conceivable constellation of carrousel sizes and rotating star-shaped element sizes.

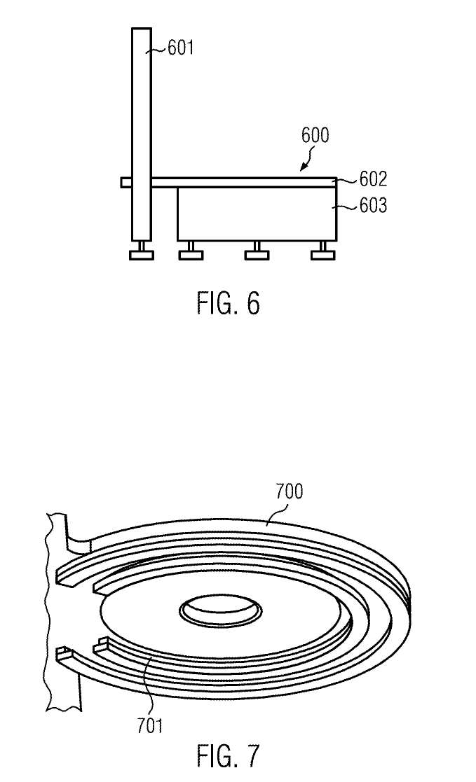

FIG. 6 illustrates yet another advantage of correspondingly sized table plates. For instance, table plate 600 can be used to establish a connection between a base support 602 to which a carrousel can be mounted and a portal used to convey containers by means of the rotating star-shaped elements to be attached at the table plate. Said portal 601 and said base support 602 may, for instance, be those components referred to in FIG. 1. Since, as described with regard to FIG. 4, the rotating star-shaped element region shall always be of the same dimensions among the entire assortment of machines for treating containers, it can be fit into a standard portal, as described in FIG. 1, that is always of the same dimension for a corresponding assortment of machines for treating containers and allows for a corresponding positioning of rotating star-shaped elements. Since, on the other hand, the size of the carrousel region 602 is adapted to the size of the carrousel, table plate 600 may always allow for an accurately fitting of the carrousel on base support 602 with regard to portal 601 so that additional elaborate aligning steps can be reduced.

FIG. 7 illustrates another embodiment of a table plate 700 according to the invention. It comprises at least one mounting arrangement 701 where, preferably around the entire circumference or in the region of the mounting arrangement shown here in C-shape, treating units or other devices can be mounted. These might be, for example, labeling units that can be provided at the periphery of table plate 700. Furthermore, table plate 700 comprises elements for mounting e.g. rotating star-shaped elements and/or a carrousel, as described in the preceding Figures.

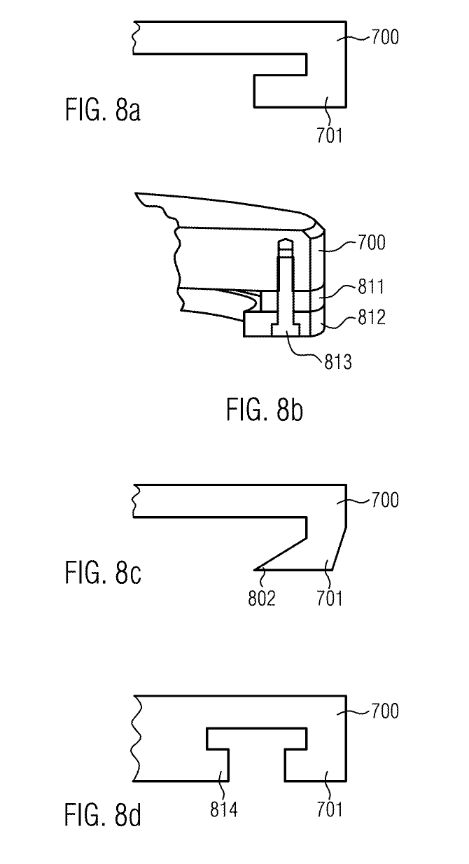

FIGS. 8a-d illustrate possible embodiments of the mounting arrangements.

According to FIG. 8a, mounting arrangement 701 and table plate 700 are an integrally formed work piece. To this, the shape of mounting arrangement 701 can be milled out from a solid work piece used to manufacture the table plate. Thus, the mounting arrangement could be stabilized considerably and also the positioning of treating units can be done always equally without adjustments or fine-alignments being required.

FIG. 8b illustrates an alternative embodiment of the mounting arrangement. According to said embodiment, one or several ring-shaped elements 811 and 812 are mounted to table plate 700, e.g. by screw connections 813. It is very easy to manufacture such ring-shaped elements which allow for a variable adaptation of the mounting arrangement for special purposes. In particular, the individual ring-shaped elements may have various shapes, thus enabling, for instance, that only specific treating units can be mounted to the table plate. Then, the mounting arrangement will take the function of a lock-and-key-principle, together with the treating element to be mounted thereto.

FIG. 8c illustrates an alternative embodiment of mounting arrangement 701. To this, an inclination 802 or notch is additionally provided which, according to the example as shown, is formed by pointing away from an imaginary axis V of a carrousel to be mounted at the table plate. It may also be provided such that it points towards said axis V, the advantage being in that treating elements are guided through the notch into the mounting arrangement. Thus, treating elements can be introduced and mounted in an utmost trouble-free manner, in particular without getting tilted. Even though the embodiment shown in FIG. 8c including a notch is here just shown for an integral workpiece consisting of the mounting arrangement and the table plate, it may also be realized by means of the ring-shaped components forming the mounting arrangement being described with regard to FIG. 8b. Preferably, one of the ring-shaped components will then be provided with such a notch.

FIG. 8d illustrates yet another alternative embodiment of mounting arrangement 701. In this case, there is not only provided the mounting arrangement as already shown but also another mounting arrangement 814 opposite thereto, so that a treating unit or similar components can be mounted from two sides, thus further increasing the stability. Said second mounting arrangement 814 can be realized either by ring-shaped components located further inward or by correspondingly milling a solid work piece which is to be shaped so that it forms a table plate with mounting arrangement. Also conceivable are combinations, wherein e.g. the mounting arrangement given reference number 701 in FIG. 8d is formed by milling and the second mounting arrangement 814 is formed by ring-shaped components, or vice versa.

In principle, the form of the mounting arrangement is flexible. But preferably, it will be realized in the form of a circle entirely extending along the circumference of the table plate, or in a C-shape as shown in FIG. 7. It is also conceivable to provide a variety of mounting arrangements at an imaginary circle along the circumference, which are spaced apart from each other so that treating units can be mounted only at specific locations. In such a case it may also be advantageous to design the mounting arrangements so as to be suitable only for a specific treating unit, respectively, e.g. by a specific form or length of the mounting arrangement.

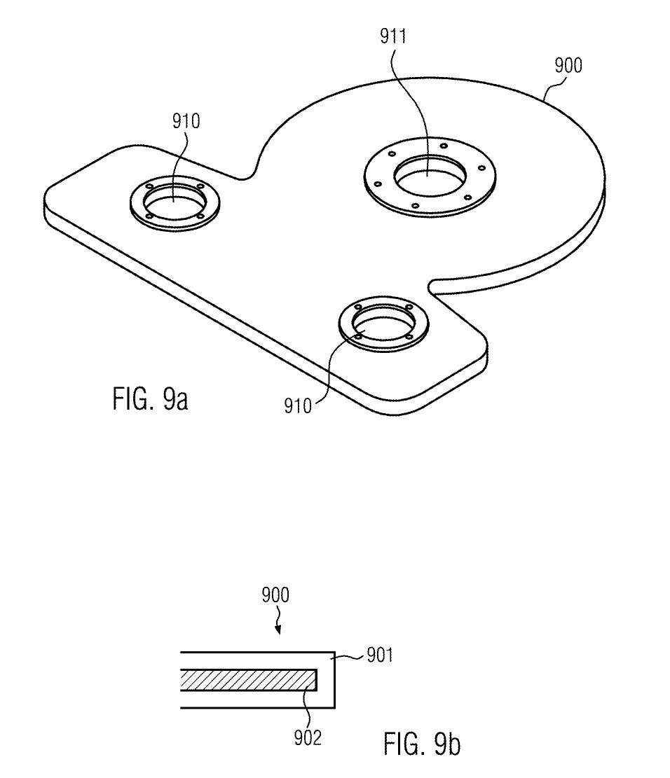

FIG. 9 illustrates yet another table plate according to the invention. FIG. 9a shows an exterior view and FIG. 9b shows a cross-sectional view through table plate 900. According to FIG. 9a, table plate 900 preferably comprises bores 910 and 911 into which shafts or mountings for rotating star-shaped elements (bores 910) and, if required, a carrousel (bore 911) can be inserted. To this end, table plate 900 is provided with a lamination preferably extending across the entire table plate but which can also be provided only at specific locations. Said lamination may include specific advantageous properties. For instance, it may be of the kind that is easy to clean or dirt-resistant (lotus effect). It may also have bulges or bulbs that prevent labels from adhering. Moreover, said lamination may also be a multilayer, with each layer being adapted to specific requirements or including specific properties.

FIG. 9b illustrates a cross-section of table plate 900. Table plate 900 is preferably made of a one-piece solid core 902 consisting e.g. of stainless steel or a different material. Said core is surrounded by a coating or lamination 901. Said coating can be made of plastic material, for instance, and can be applied, i.a. to the core material within the course of an injection-molding process. The bores illustrated in FIG. 9a may be formed in said table plate either before or after the lamination process of the core material 902. Preferably, the core material has a thickness of 2 mm up to 1 cm. The lamination may also range from some few mm up to a larger number of cm.

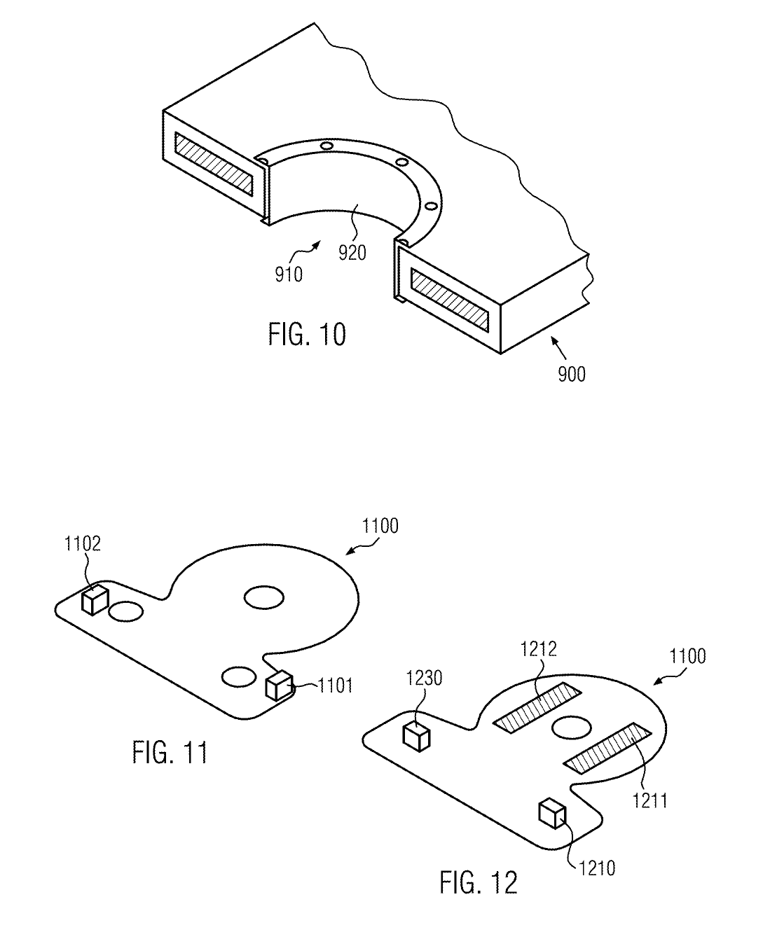

FIG. 10 illustrates an embodiment of table plate 900, with the bores being restricted by ring-shaped elements 920. Said elements 920 are inserted into the bores and preferably have the profile as shown so that they extend along the upper side and the lower side of the table plate shown here across a region of the lamination. As such components like shafts or the like are introduced into bores 910 and 911 in order to fix specific units, it may turn out advantageous when the ring-shaped component is made of a solid material, e.g. stainless steel and has, at the same time, a specific form which allows, for instance, introducing shafts in just one specific orientation. Thus, construction errors can be avoided. Although the ring-shaped component 920 is here shown as a separate component that will be inserted into the boring after lamination has taken place, said ring-shaped component may also be provided in the form of a bulge or protrusion of core material 902 of FIG. 9. The lamination would then, indeed, reach up to such bulge, the core material, however, would remain exposed in this region. In such a case it is advantageous when the core material is stainless steel. But, if the core material is entirely enclosed by such lamination it may consist of more affordable materials such as aluminum or non-stainless steel. Furthermore, it may be advantageous when table plates are always manufactured with bores of the same size and any adaptation for an assortment which uses, e.g. shafts of different thicknesses is done by means of various ring-shaped components.

FIG. 11 illustrates another embodiment of a table plate 1100 according to the invention. In addition to any bores for mounting rotating stars and a carrousel, said table plate is provided with columns 1101 and 1102 where motors for driving e.g. the rotating star-shaped elements can be accommodated. Apart from said columns, line ducts may also be provided suited for accommodating, for instance, power cables or electrical connections. Thus, protection of said sensitive components against environmental influences has been achieved.

FIG. 12 illustrates an embodiment of said table plate from below, wherein due to the space-savings achieved by positioning motors in columns at the upper side, the lower side offers space for accommodating further devices (1210, 1211, 1212, 1213) such as power supplies or lines and pneumatics. To design the table plate in this form allows for a coupling of the rotating parts such as rotating star-shaped elements by means of electrical means, i.e. just by means of cable connections, without shafts for transmitting the torque being required, thus rendering the entire arrangement considerably lighter and less prone to failure. Due to the space-savings, the lower side may also be provided with power supplies and lubricating systems. Thus, a considerably more compact structure could be achieved.

What is claimed is:

1-37. (canceled)

38. A table plate for a machine for treating containers, particularly a labeling machine, said table plate comprising a carrousel portion where a carrousel can be positioned and pivotally connected to the table plate;
said table plate comprising a rotating star-shaped element region where at least one rotating star-shaped element for supplying or discharging containers to or from the carrousel can be arranged and pivotally connected to the table plate;
said table plate being formed as a solid and one-piece work piece.

39. The table plate according to claim 38, the table plate comprising a motor region where motors can be arranged at least one of in columns provided on the table plate or at least one of inside or outside at the side of the carrousel position of the table plate.

40. The table plate according to claim 38, the carrousel and a portal through which containers can either be supplied to or be discharged from the carrousel can be connected with one another via the table plate.

41. The table plate according to claim 38, and elements for guiding and fastening electrical and mechanical systems are provided at the side of the table plates facing away from the carrousel.

42. An assortment of table plates according to claim 38 for an assortment of machines for treating containers, outer dimensions of the rotating star-shaped element region for each of said machines for treating containers among the assortment of machines for treating containers being identical, and a distance of receptacles in a table plate for a rotary wheel of an inlet star and a rotary wheel of an outlet star in said rotating star-shaped element region where the rotating star-shaped elements can be pivotally supported for machines for treating containers among the assortment of machines for treating containers differ from each other.

43. The assortment of table plates according to claim 38, outer dimensions of the carrousel region of at least two table plates among the assortment differ from each other, and a position in which a main axis of the carrousel can be arranged and pivotally supported in said carrousel portion of at least two table plates of the assortment show a different distance from the rotating star-shaped element region.

44. A table plate for a machine for treating containers, which comprises a carousel, wherein at least said carousel can be mounted to the table plate, said table plate comprising a mounting arrangement supported by said table plate and to which treating units can be mounted at a side facing away from a carrousel position.

45. The table plate according to claim 44, wherein at least one of:
the mounting arrangement comprises at least two, a first and a second, ring-shaped elements arranged one upon the other concentrically with regard to a rotation axis of the carrousel and towards the rotation axis of the carrousel, the first ring-shaped element being connected to the table plate via a connection,
the mounting arrangement consists of an ring-shaped element or includes same; or
the first ring-shaped element has one of a larger inner diameter than the second ring-shaped element or a smaller outer diameter than the second ring-shaped element.

46. The table plate according to claim 44, wherein at least one of:
the mounting arrangement and the table plate are integrally formed and made from one work piece;
mounting arrangement is formed in at least one of a C-shape or a groove; or
at least one of the mounting arrangement comprises notches converging towards the rotation axis of the carrousel in table plate direction, or the mounting arrangement comprises notches diverging from the rotation axis in table plate direction.

47. A table plate for a machine for treating containers, which comprises a carousel to be arranged at the table plate, the table plate including a laminated core material.

48. The table plate according to claim 47, wherein at least one of:
the core material including one of stainless steel, non-stainless steel, or aluminum; or
the lamination is made of or includes a plastic material.

49. The table plate according to claim 47, the table plate provided with a bore designed to mount machine parts, wherein a ring-shaped component is inserted into said bore.

50. The table plate according to claim 49, the ring-shaped component being at least partially made of stainless steel.

51. The table plate according to claim 47, the table plate being at least one of the following:
dirt-resistant,
color-resistant,
flexible,
provided with bulges, or
non-sticky.

52. A table plate for a machine for treating containers, which comprises a carousel to be arranged at the table plate, wherein containers to be treated can either be conveyed to or from to the carrousel by means of rotating star-shaped elements to be arranged at the table plate, the columns, in which space for motors for driving the rotating star-shaped elements is provided, are mounted to the table plate at the side of the carrousel position, wherein said rotating star-shaped elements are of an electrically coupled form.

53. The table plate according to claim 52, means for mounting further components are provided at the side facing away from the carrousel position of the table plate, wherein a coupling of said components can be provided with an electric motor.

54. The table plate according to claim 52, the motors being servomotors.

55. The table plate according to claim 52, means for mounting at least one of the wiring, control device, power supply, pneumatics, lubricating system are provided at the side facing away from the carrousel position of the table plate.
